(19) United States
(12) Patent Application Publication
(10) Pub. No.: US 2016/0299291 A1
(43) Pub. Date: Oct. 13, 2016

(54) PLASMONIC WAVEGUIDES AND WAVEGUIDING METHODS

(71) Applicant: Ziva Corporation, San Diego, CA (US)

(72) Inventors: David F. Smith, Ellicott City, MD (US); Vladimir Grigoryan, Elkridge, MD (US); Alok Mehta, San Diego, CA (US)

(21) Appl. No.: 15/097,210

(22) Filed: Apr. 12, 2016

Related U.S. Application Data
(60) Provisional application No. 62/146,954, filed on Apr. 13, 2015.

(51) Int. Cl. G02B 6/122

(52) U.S. Cl. CPC G02B 6/1225

(57) ABSTRACT

A plasmonic waveguide structure with highly confined field and low propagation loss is disclosed. In selected embodiments, the structure has a sub-wavelength size dielectric core surrounded by stacks. Each stack includes multiple repeating, alternating metal layers and dielectric layers. The stacks operate in bandgap condition to render a highly-confined and low propagation loss waveguide structures that can be made using commercially available fabrication techniques.

### CROSS-REFERENCE TO RELATED APLICATIONS

The present application claims priority from U.S. Provisional Patent Application Ser. No. 62/146,954, entitled PLASMONIC WAVEGUIDES AND WAVEGUIDING METHODS, filed on 13 Apr. 2015.

### FIELD OF THE INVENTION

This document relates generally to plasmonic structures and methods for guiding plasmonic waves.

### BACKGROUND

A conventional optical waveguide causes light to propagate in a core dielectric guiding layer by surrounding the core dielectric guiding layer with additional dielectric layers that have a refractive index lower than the core layer; the additional dielectric layers may be referred to as the “cladding” of the waveguide. This arrangement results in total internal reflection of a propagating optical signal at the interface between the core and the surrounding cladding layers, confining the optical signal to the core. Perhaps such waveguides are more correctly designated as “dielectric” optical waveguides. In dielectric substrates, however, the difference in refractive indices is generally small, and hence the field propagating along the core in general can only propagate at very shallow angles before it exceeds the limits of total internal reflection, causing leakage of the optical signal from the core. The maximum propagation angle of an optical mode may be determined by the size of the optical mode compared to the wavelength of the light being propagated in the waveguide. As the mode diameter approaches the wavelength of the light, the propagation angle increases until it spreads in many directions. This effect generally prevents dielectric optical waveguides from confining light to dimensions much smaller than 5-10 times the wavelength of the light. Hence a conventional optical fiber transmitting light at 1.55 microns requires a core of the order of 10-15 microns diameter to avoid the optical signal leakage from the core. This can make it impossible to design simple dielectric waveguides that confine the optical signal to near-wavelength and sub-wavelength dimensions.

The reflectivity of the optical signal at a boundary between two materials may be increased by replacing the simple cladding layer with a cladding made of multiple layers with alternating higher and lower refractive indices. An example of such arrangement is the Bragg Grating structure. If such a structure is used as the cladding in an optical dielectric waveguide, however, it may work very efficiently to reflect incident optical signals propagating over a narrow range of angles. Hence it may provide total internal reflectivity for optical fields propagating at shallow angles as described above and a high Bragg reflectivity for fields propagating at angles around 90 degrees (substantially perpendicular to the stack), but it may provide little reflectivity at the angles in-between the two extremes. Hence, effectively confining a mode to dimensions near and less than the wavelength of the light is still difficult.

An additional problem also arises in dielectric optical waveguides: Reduction in the size of an optical mode in a dielectric waveguide to a dimension smaller than the wavelength of the light causes the optical mode to experience cut-off, which means that the light can no longer propagate as a mode. This operates in addition to the high losses resulting from the leakage. For this reason, techniques for confining and guiding sub-wavelength size optical modes in dielectric waveguides remain elusive.

Generally, a plasmonic waveguiding system has a dielectric core layer surrounded by adjacent metal layers. When a thin dielectric insulator layer (I) of material such as silicon is placed between two metal layers (M) made of metals such as silver, for example, a Metal-Insulator-Metal (MIM) plasmonic waveguide results. FIG. 1 illustrates a cross-section of an example of an MIM waveguide.

In the example of FIG. 1, an optical signal may propagate along the x direction in the dielectric core layer 110 and is confined to the layer 110 by reflection from the surrounding metal layers 120. For example, in a Si/Ag MIM waveguide operating at a wavelength of 1.55 microns, the total internal reflection (TIR) angle at the dielectric /metal interface may now be approximately 82 degrees, defined from the horizontal. Different materials may produce different TIR angles. However, there is little reason to use an MIM waveguide to guide optical modes significantly larger than the wavelength of the light, because MIM waveguides generally have very high absorption loss due to the evanescent field penetrating into the metallic cladding. Losses of 104-106 dB/cm are typical in plasmonic waveguides of this type, versus losses of about 0.5 dB/km that are typical in fiber optic dielectric waveguides.

Plasmonic MIM waveguides have an additional property that makes light behavior in such waveguides qualitatively different from light behavior in dielectric waveguides: as the size of the optical mode in an MIM waveguide is reduced below the size of the wavelength, the MIM waveguide does not experience modal cut-off. Technically, the mode continues to propagate, albeit with very high loss. Low loss dielectric waveguides generally cannot operate in this way. Hence, a plasmonic MIM waveguide can be used to confine optical modes to dimensions much smaller than the wavelength of the light. For example, it may be possible to confine optical signals at 1.55 microns to dimensions of 20 nm or less. In a sense, under these conditions, one could say that the optical signal is now propagating by converting the fluctuations in the incident E-field into fluctuations of the density of electrons in the metal. The tight binding of the field to the metal may be powerful enough to allow MIM waveguides to turn round 90 degree corners, which might be impossible for an optical signal in other structures. This makes the device useful for carrying signals on a very small scale, such as signals between and/or on electronic chips.

An explanation of the various applications of plasmons to signal propagation may be found, for example, in Bozhevolnyi, S., et al., Plasmonic nanoguides and circuits (Pan Stanford Publishing 2009), which document is incorporated herein by reference in its entirety, including figures, tables, footnotes, and all other matter.

The usefulness of plasmonic waveguides would be improved by lower propagation loses. A need exists in the art to provide techniques for reducing propagation losses in plasmonic waveguides, and for plasmonic waveguides with reduced propagation losses.

### SUMMARY

Embodiments, variants, and examples described in this document are directed to methods, apparatus, and articles of manufacture that may satisfy one or more of the above described and/or other needs.

In exemplary embodiments described throughout this document, Stack-Insulator-Stack (SIS) plasmonic waveguide designs are disclosed. Selected SIS plasmonic waveguide designs enable optical signals to propagate through regions of confinement substantially smaller than the standard diffraction limit of λ/n along one or more dimensions, where λ is the free space wavelength and n is the refractive index of the waveguide core region. In aspects, the disclosed SIS structures include a dielectric core region surrounded by regions with resonant, periodic, metal/dielectric stacks designed to operate in bandgap mode/condition (which mode/condition will be described in more detail below), and where the stacks are designed so that there are metal layers directly adjacent to the dielectric core region.

In an embodiment, a plasmonic waveguide includes a first stack, a second stack, and a core dielectric layer. The core dielectric layer is sandwiched between the first stack and the second stack. The first stack and the second stack operate in a bandgap condition.

In aspects, the first stack includes a first plurality of metal layers and a first plurality of stack dielectric layers separating the layers of the first plurality of metal layers; and the second stack comprises a second plurality of metal layers and a second plurality of stack dielectric layers separating the layers of the second plurality of metal layers.

In aspects, the thickness of each metal layer of the first and second pluralities of metal layers is equal to a first metal thickness dimension, and thickness of each stack dielectric layer of the first and second pluralities of stack dielectric layers is equal to a second dielectric thickness dimension.

In aspects, thickness of each metal layer of the first and second pluralities of metal layers is substantially equal to a first metal thickness dimension, and thickness of each stack dielectric layer of the first and second pluralities of stack dielectric layers is substantially equal to a second dielectric thickness dimension.

In aspects, the first stack includes a first plurality of metal layers and a first plurality of stack dielectric layers separating the layers of the first plurality of metal layers; the first plurality of metal layers includes a first adjacent metal layer that is adjacent to the core dielectric layer and two or more other metal layers of the first plurality of metal layers; the second stack includes a second plurality of metal layers and a second plurality of stack dielectric layers separating the layers of the second plurality of metal layers; the second plurality of metal layers includes a second adjacent metal layer that is adjacent to the core dielectric layer and two or more other metal layers of the second plurality of metal layers; thickness of each metal layer of the two or more other metal layers of the first plurality of metal layers and of the two or more other metal layers of the second plurality of metal layers is equal to a first metal thickness dimension; and thickness of each metal layer of the first adjacent metal layer and the second adjacent metal layer is equal to a second metal thickness dimension that is different from the first thickness dimension.

In an embodiment, a plasmonic waveguide includes a first stack, a second stack, and a core dielectric layer. The core dielectric layer is sandwiched between the first stack and the second stack. The first stack and the second stack operate in bandgap condition, and are designed to enable an optical mode to propagate along the core dielectric layer with a dimension substantially smaller than the wavelength of light of the optical mode.

In aspects, the propagation loss of the mode is reduced below propagation loss of an equivalent MIM waveguide.

In aspects, the propagation loss of the mode is reduced by at least two orders of magnitude below the propagation loss of the equivalent MIM waveguide.

In aspects, the propagation loss of the mode is reduced due to reduction of the level of the optical field in the metal regions of the waveguide.

In an embodiment, a plasmonic waveguide includes a core dielectric layer; and means for enabling an optical mode to propagate along the core dielectric layer with a propagation loss per unit length along direction of propagation is below propagation loss per unit length of an optical mode propagating along a dielectric layer of a Metal-Insulator-Metal (MIM) optical waveguide with a dielectric layer similar to the core dielectric layer in dimensions and optical properties.

In an embodiment, a metal/dielectric stack is made so that the stack's reflectivity remains at its maximum level over a wide range of angles of incidence of the optical signal. For example, the reflectivity remains above 90% over a range of angles of incidence ranging from 0 degrees to 75 degrees.

In an embodiment, a metal/dielectric stack includes means for confining and guiding an optical signal in two dimensions.

In an embodiment, a metal/dielectric stack is optimized for low loss plasmonic confinement and is further optimized to account for non-local effects.

In an embodiment, a plasmonic waveguide includes a substantially cylindrical core dielectric guide and a substantially cylindrical stack surrounding the core dielectric guide, wherein the stack operates in a bandgap condition.

In aspects, the stack includes a plurality of substantially cylindrical metal layers and a plurality of substantially cylindrical stack dielectric layers separating the layers of the first plurality of metal layers.

These and other features and aspects of the present invention will be better understood with reference to the following description, drawings, and appended claims.

### BRIEF DESCRIPTION OF THE FIGURES

FIG. 1 illustrates selected features of a cross-section of an example of a Metal-Insulator-Metal waveguide;

FIG. 2 illustrates selected features of a cross-section of an example of a Stack-Insulator-Stack waveguide;

FIG. 3 illustrates in perspective selected features of an example of a Stack-Insulator-Stack waveguide; and

FIGS. 4, 5, 6, 7, 8, 9, 10, and 11 show selected parameters and data of simulations of Stack-Insulator-Stack waveguiding structures.

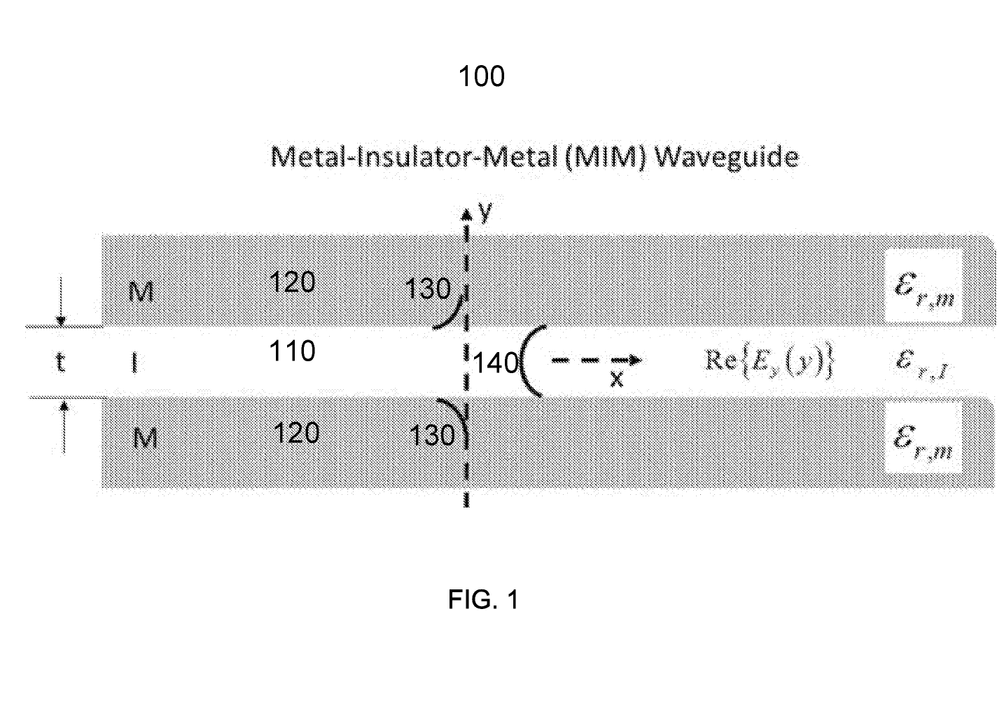

### DETAILED DESCRIPTION

The words “embodiment,” “variant,” “example,” and similar words and expressions as used here refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar words and expressions are used to indicate one of a number of different possible embodiments, variants, or examples. The number of possible embodiments, variants, or examples is not necessarily limited to two or any other quantity. Characterization of an item as “exemplary” means that the item is used as an example. Such characterization does not necessarily mean that the embodiment, variant, or example is preferred; the embodiment, variant, or example may but need not be a currently preferred embodiment, variant, or example. All embodiments, variants, and examples are described for illustration purposes and are not necessarily strictly limiting.

The words “couple,” “connect,” and similar expressions and words with their inflectional morphemes do not necessarily import an immediate or direct connection, but include within their meaning connections through mediate elements.

In plasmonic systems, the propagating optical signals are typically at carrier wavelengths in the infrared (IR) and visible parts of the electromagnetic spectrum. Infrared wavelengths are generally considered to lie above 700 nm, while visible light is generally considered to cover the range from about 400 nm to the beginning of the IR range, about 700 nm. Selected plasmonic systems operate at carrier wavelengths of 780 nm, 850 nm, 1.3 micron, and 1.55 microns, by creating disturbances in the electron plasma contained in a metal layer. However, biosensing applications often operate at UV wavelengths 200-400 nm and the same principles can be applied there.

Some definitions have been explicitly provided above. Other and further implicit and explicit definitions and clarifications of definitions may be found throughout this document.

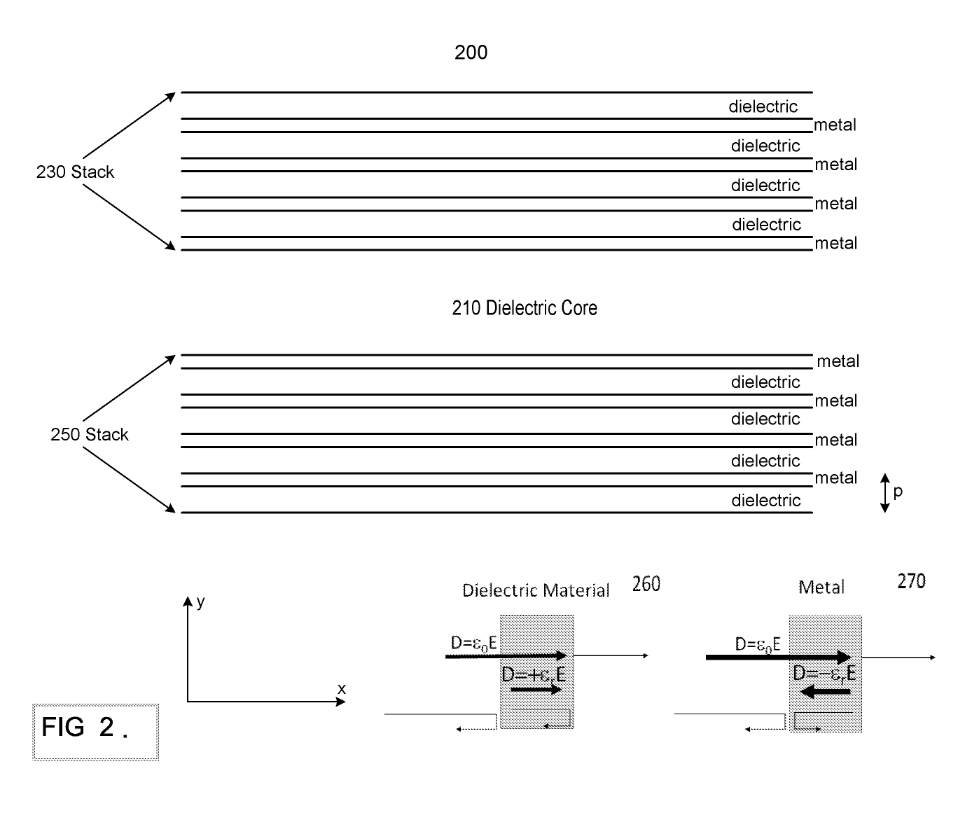

FIG. 2 illustrates a cross-section of a SIS waveguide 200. The waveguide 200 is planar, with its various layers extending in the x dimension as shown, and in the z dimension that is normal to the plane of the Figure. Reference numeral 210 designates a dielectric core layer of the waveguide 200. The numerals 230 and 250 designate, respectively, a first and second “stacks.” Each of the stacks 230/250 has a number of metal layers and dielectric layers, arranged periodically on the y dimension. Note that the dielectric of the stacks may be the same or similar to the dielectric of the core layer 210; it may also differ from the material of the core layer 210. Additionally, the various dielectric layers of the stacks 230/250 may be made of the same dielectric material, or different dielectric materials. Similarly, the metals of the different layers of the stacks 230/250 may be the same or they may differ. In specific embodiments, however, the metal layers of the stacks 230/250 are all made of the same or substantially the same metal, and the dielectric layers of the stacks 230/250 are also of the same dielectric material.

The period of the stacks 230/250 in the y dimension is designated as “p.” It follows that in the embodiment illustrated in FIG. 2, the metal layers of the stacks 230/250 all have the same or substantially the same thickness; and the dielectric layers of the stacks 230/250 also all have the same or substantially the same thickness, which may be different from the thickness of the metal layers. The period p is then the sum of the thickness of a single dielectric layer and the thickness of a single metal layer of the stacks, as shown. Note that in other embodiments it is possible for all or some of the layers in the stack to have different thicknesses. In specific embodiments, the dimensions of the two stacks are the same or substantially the same. In specific embodiments, the metal layers adjacent to the core layer 210 are thicker than other metal layers of the stacks; the other metal layers may be of the same or substantially same thickness.

To understand the operation of an SIS waveguide, such as the waveguide 200 of FIG. 2, note that a periodic structure, either dielectric/dielectric or metal/dielectric, can be designed so that it presents a bandgap to any signal attempting to pass through the waveguide perpendicular to the plane of the interface (the y direction in the same Figure). Similar to the operation of a Bragg filter in optical technology, a band gap prevents propagation in the y direction of FIG. 2 through the resonant structure resulting in total internal reflection of the wave, which may permit the wave to propagate in the x direction with no loss due to leakage of the mode. However, the mode may experience loss due to any form of absorption or scattering as it propagates in the x direction.

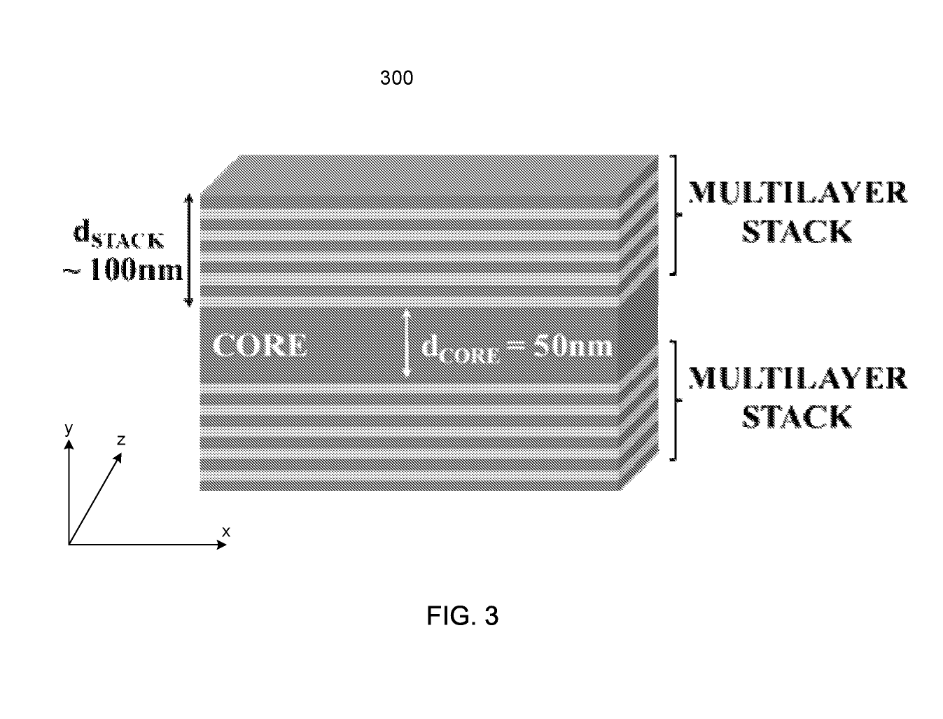

FIG. 3 is a perspective view of a portion of a waveguide 300, similar to the waveguide 200 of FIG. 2. Here, however, the thickness of the core layer (d_{core}) is shown as 50 nm, the thickness of each of the stacks (d_{stack}) is about 100 nm, and each of the stacks includes five dielectric layers interspersed with five metal layers, with one metal layer of each of the stacks adjoining the core dielectric layer. The dimensions of the waveguide 300 are not necessarily drawn to scale.

In variants of the waveguide 300, the thicknesses of the stack layers are 10.5 nm for the metal layers and 8.3 nm for the dielectric layers. Exact dimensions for any specific set of materials and wavelengths are such that efficient bandgap operation and appropriate angular support for the wavelength under consideration are achieved. Different metals can be used and different dielectrics can be used, including semiconductors. Material selection is such that the metal supports the propagation of surface plasmon polaritons at the wavelength of operation. Metals such as Au, Ag or W are commonly used for this purpose, but materials such as graphene are also acceptable. A wide range of dielectrics can be used, including Si, SiO₂ and Al₂O₃. The dielectric in the core guiding region may be optimized for propagation at the same wavelength.

The thickness of the core dielectric layer is not limited to 50 nm, but may vary; in specific examples, however, the core layer thickness d_{core} is much less than one-half wavelength of the optical signal in the material. In other words, d_{core}<<λ/2, where λ is the wavelength of the optical signal in the dielectric material (free-space wavelength adjusted by the dielectric constant of the material). Typical values of d_{core} may be in the 20-100 nm range, although we contemplate embodiments with smaller and larger thicknesses.

The number of metal-dielectric layers in each of the stacks may be ten or fewer. As is shown in FIG. 3, five pairs of metal-dielectric layers may be present in each stack, but the number may be four, three, or two; the number of pairs may also be between five and ten (six, seven, eight, nine); and more than ten pairs may also be present. Moreover, as has already been mentioned, the number of metal layers may be different from the number of dielectric layers in the stacks, with a stack having a metal layer on the side of the core and another metal layer on its opposite side.

We now discuss the “bandgap” concept. “Bandgap” is a resonant condition that essentially forbids propagation through the region. In the waveguide 200 and 300, there would be no propagation of the optical signal in the y dimension/direction. This is not simply high-loss propagation, but a resonant condition where no Poynting vector exists in the given direction (y direction in FIG. 2 and FIG. 3). Since no propagation occurs through the stack (in the y direction) under this bandgap condition, then no propagation loss occurs in the y direction. The bandgap condition prevents or reduces the leakage of the optical signal from the waveguide region. The details of the thicknesses of the various layers (metal and dielectric layers of the stacks) depend on the dielectric coefficients of the materials involved at the wavelength of operation. The opposite of a bandgap structure is a bandpass structure designed to transmit the signal through the structure. Bandgap and bandpass concepts are discussed in M. Scalora, M. J. Bloemer, and C. M. Bowden, “Laminated photonic band structures with high conductivity and high transparency: Metals under a new light,” Opt. Photonics News 10, 23-27 (1998); M. Scalora, G. D'Aguanno, N. Mattiucci, M. J. Bloemer, D. de Ceglia, M. Centini, A. Mandatori, C. Sibilia, N. Akozbek, M. G. Cappeddu, M. Fowler, and J. W. Haus, “Negative refraction and sub-wavelength focusing in the visible range using transparent metallodielectric stacks,” Opt. Express 15, 508-523 (2007); and M. R. Gadsdon, J. Parsons, and J. R. Sambles, “Electromagnetic resonances of a multilayer metal/dielectric stack,” J. Opt. Soc. Am. B 26, 734-742 (2009). Each of these publications is hereby incorporated by reference in its entirety as if fully set forth herein, including figures, tables, footnotes, and all other matter.

Although many different layer thicknesses and combinations may produce a bandgap structure, not all bandgap structures operate with low loss, since the resonant conditions of the structure may be different resulting in different losses due to different degrees of penetration of the evanescent field into the metallic layers. If the resonant conditions result in a substantial amount of power residing in the metallic regions, then the stack will likely show significant loss due to metallic absorption of the evanescent tail, even though it is operating in a bandgap state. Dielectric/dielectric stacks (e.g., Bragg Gratings) can show very high reflectivity with minimal absorption loss. In these structures, alternating dielectric layers with slightly different refractive indices are used to create a bandgap effect. In such structures, as in SIS waveguides, when the structure operates in a bandgap mode, although no light actively propagates through the stack, there is still an equilibrium level of light “trapped” in the different dielectric regions. The structure of the device is such that the phases of the optical fields actively cancel at the output of the grating and reinforce at the input of the grating, creating a high reflectivity device, but cancellation does not occur inside the device. Since the loss of dielectric is almost zero, however, the loss experienced by the light trapped in the device may be relatively low (typically less than 0.05 dB [per cm]), even though the light levels remain high in both regions of the dielectric. If the dielectrics used are lossy, then a moderate degradation of the quality of the resonance and, consequently, the bandgap occurs, resulting in lower reflectivity, the emergence of light leaking through the structure and greater internal absorption loss of the light.

In metal/dielectric stacks, the metal regions are generally highly lossy, in some cases with loss almost eleven orders of magnitude greater than loss in a similarly-dimensioned equivalent dielectric region. This high loss in the metal regions could make it impossible to obtain an efficient bandgap structure using conventional designs of resonant dielectric stacks. Nevertheless, highly resonant metal/dielectric stacks may be observed despite the high loss of the metal regions. (See M. Scalora, M. J. Bloemer, and C. M. Bowden, “Laminated photonic band structures with high conductivity and high transparency: Metals under a new light.”)

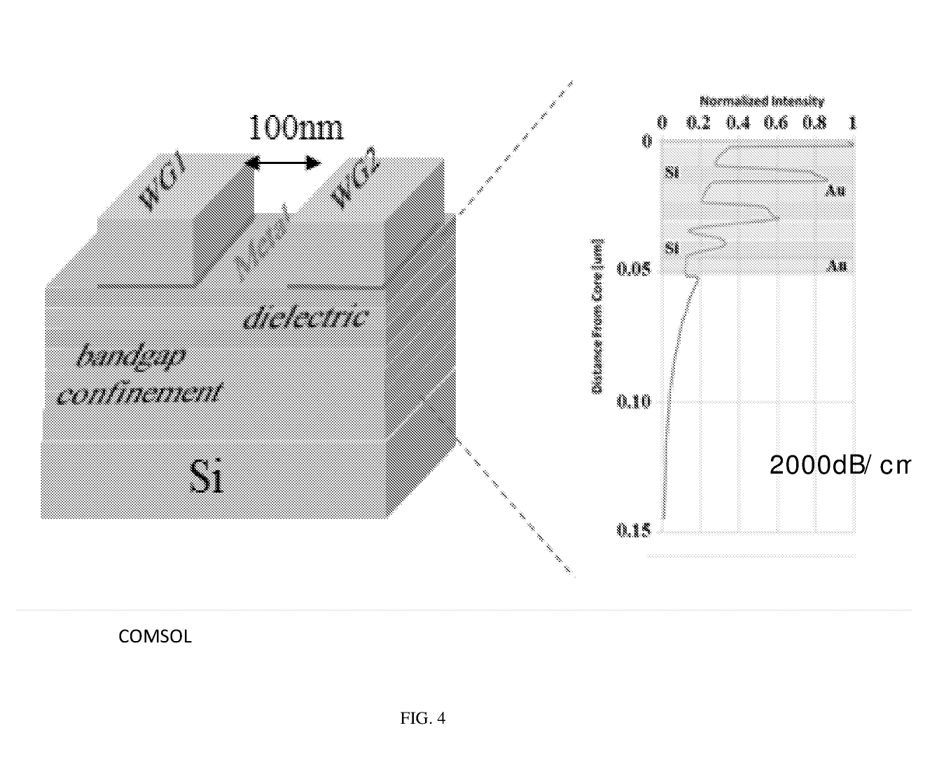

We have identified a feature of metal dielectric stacks that is not available in all dielectric stacks. The negative real component of the dielectric coefficient εᵣ of a metal enables a new factor to be included in the design, namely the ability to produce cancellation of the optical field in the metallic regions. Inset 260 in FIG. 2 shows that when an external electric field illuminates a dielectric, the induced D field in the dielectric points in the same direction as the external field. The only fields that can propagate in the reverse direction are fields which are reflected at the dielectric interface, and are by necessity weaker than the propagating field. Inset 270 in the same Figure, however, shows that the induced D field=−εᵣE points in the opposite direction to the incoming D field. This induced field may be much stronger than the reflected fields, although levels of reflection between metal and dielectric may also be much larger than those between dielectric-dielectric interfaces. The change in direction enables the possibility of a design that allows cancellation of the fields locally in the lossy metal regions, and due to energy conservation, reinforcement of the fields in the lower loss dielectric regions. For low loss propagation, layer thicknesses may be selected for optimized optical power cancelling within the metallic regions and optimized confinement of the power to the low loss dielectric regions, resulting in low net absorption of the evanescent tail of the optical signal. FIG. 4 shows selected results of a COMSOL simulation for an Au/Si waveguide at 1.55 microns that creates a resonant bandgap structure, and illustrates the confinement of the fields to the dielectric regions and nulling of the fields in the metal regions, with a net propagation loss of about 2000 dB/cm in the simulation. This compares with approximately 3,000,000 dB/cm for gold.

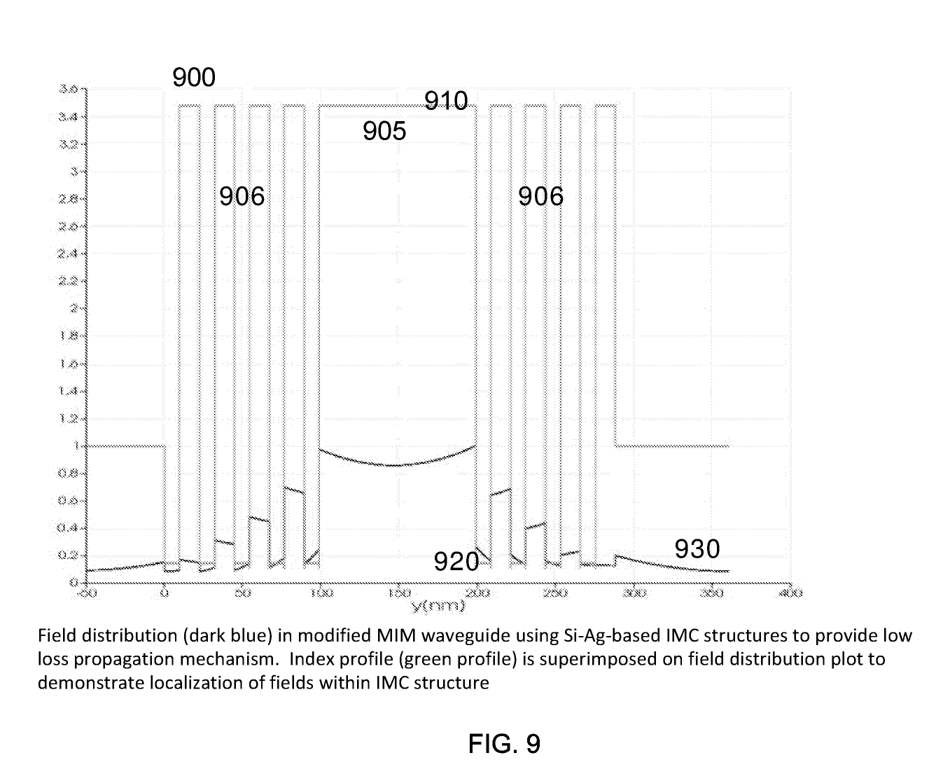

FIG. 9 shows another example of the power distribution in a Ag/Si stack. The lighter curve 900 shows the real part of the refractive index profile of the stack. The horizontal axis shows the physical thickness of the layers. The dielectric core 905 in this case is 100 nm thick. The resonant stack is denoted by 906. The levels denoted by 910 represent the real refractive index of Si, while the lower levels denoted by 920 denote the real part of the refractive index of Ag. A COMSOL simulation was performed to find the layer thicknesses that produced the lowest residual field level in the metal. For this case, the results show Si/Ag thicknesses of 10.5 nm and 8.3 nm, respectively. The darker curve denoted by 930 shows the calculated field levels across the stack. The power is significantly reduced in the metal regions.

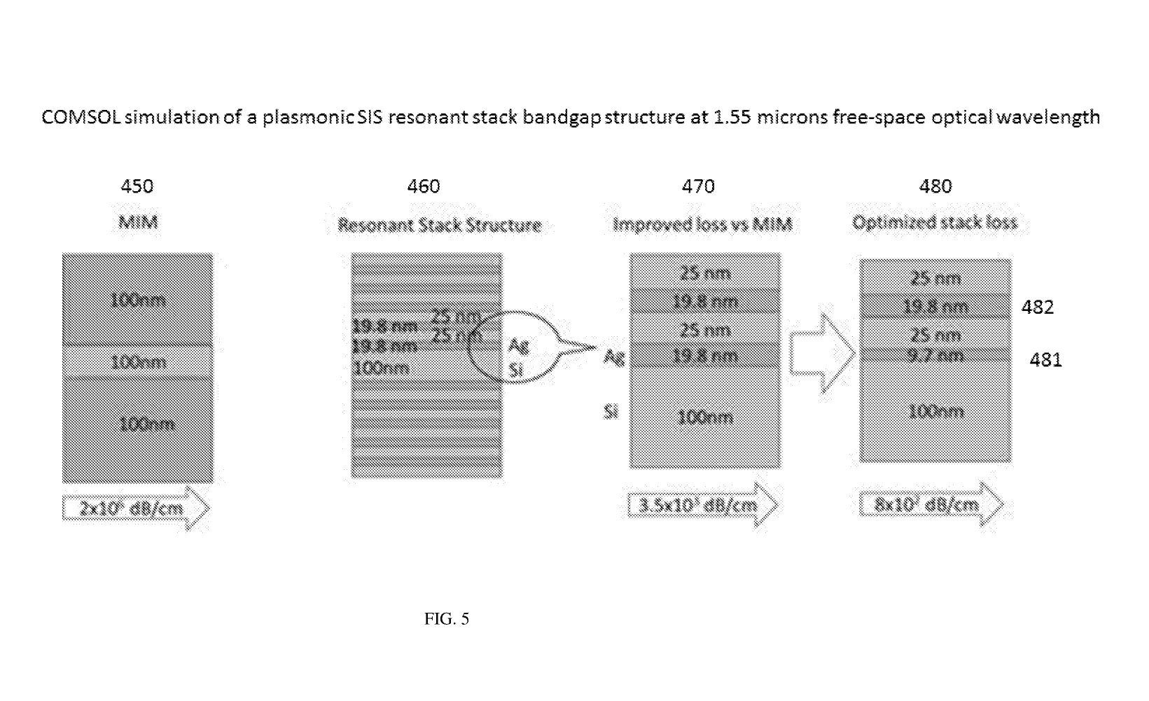

FIG. 5 shows selected results of simulations of other examples of a SIS waveguide at 1.55 microns using a 5-pair Ag/Si stack where the power is minimized in the metal regions. This time the results of the COMSOL simulation also calculate the effect of the residual optical power on the propagation loss. Example denoted with numeral 450 shows the dimensions of the original MIM waveguide. The dielectric core and each metal region were set to 100 nm thickness. The propagation loss of a mode in the dielectric core was 2×10⁶ dB/cm. Examples denoted with numerals 460 and 470 show a SIS design where the metal regions of the MIM structure were replaced above and below the core dielectric layer with bandgap Ag/Si layers. The core region remained at 100 nm thickness. The stack regions were made of five pairs of Ag/Si layers. The layer dimensions were calculated iteratively to minimize the power in the metal regions. The simulation was then used to calculate the loss of the signal propagating along the 100 nm thick core. The optimum calculated loss was 3.5×10³ dB/cm for metal layer of 19.8 nm thickness and stack dielectric layers of 25 nm thickness. This is an improvement in loss of almost three orders of magnitude. The lowest loss condition occurred when the optical power was minimized in the metal regions.

We turn now to example denoted with numeral 480. Since the bulk of the propagation loss occurs in the metal layer immediately adjacent to the dielectric core 481, a further reduction of the thickness of this layer to 9.7 nm while keeping the other layers 482 at the original thickness produced an additional reduction of the loss to 8×10² dB/cm. Further reduction of the layer thickness resulted in an increase of loss. The first metal layer adjacent to the dielectric core is therefore dealt with independently of the other metal layers of the stack, in some embodiments.

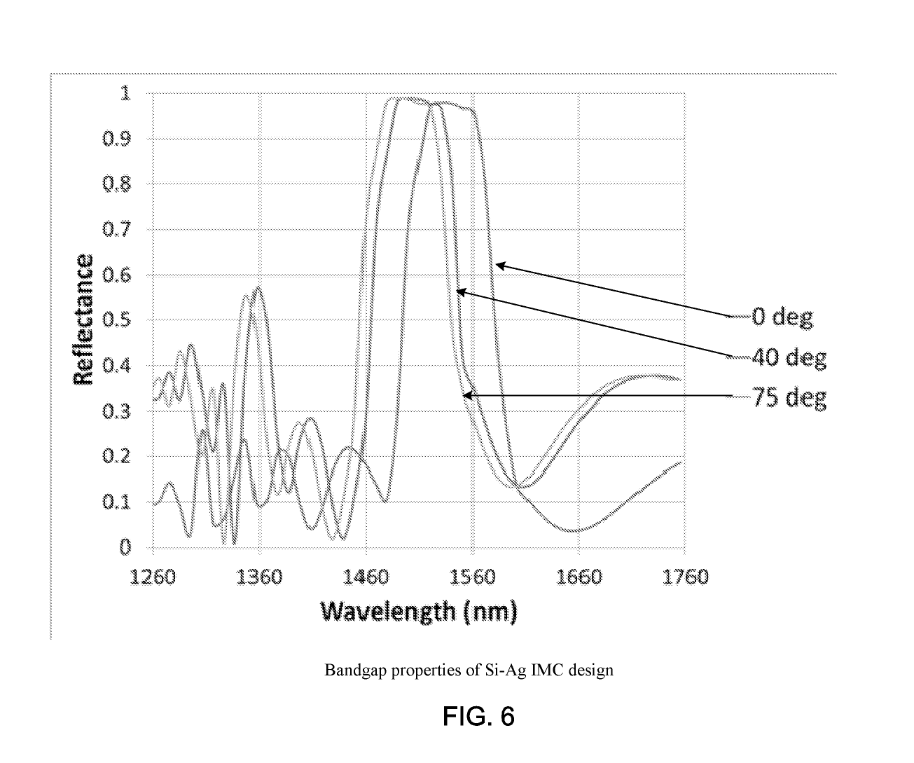

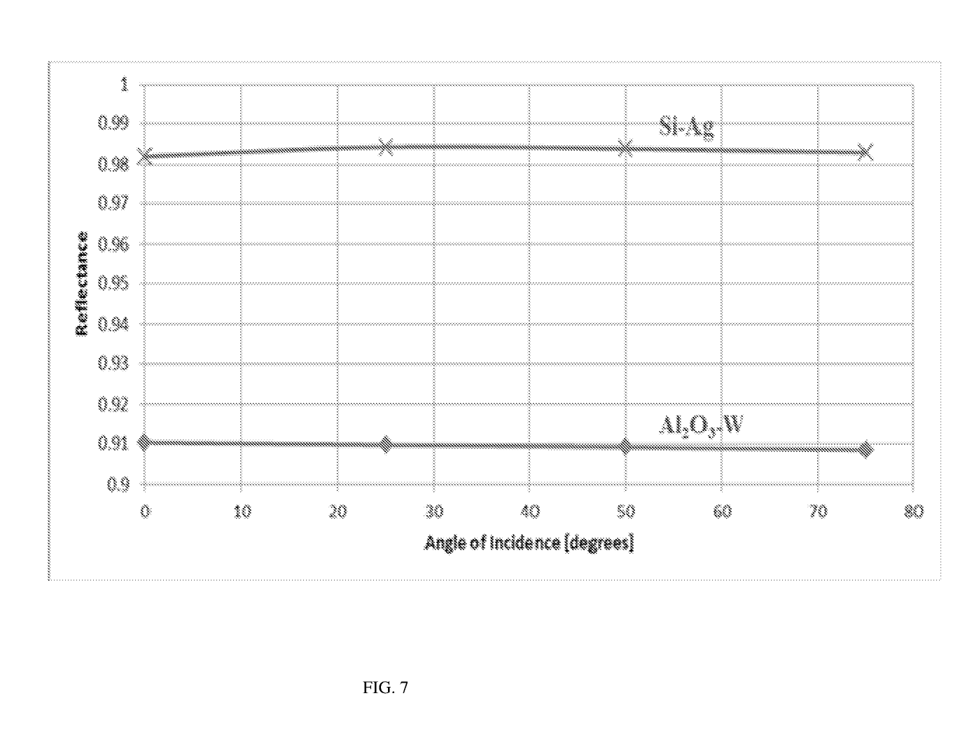

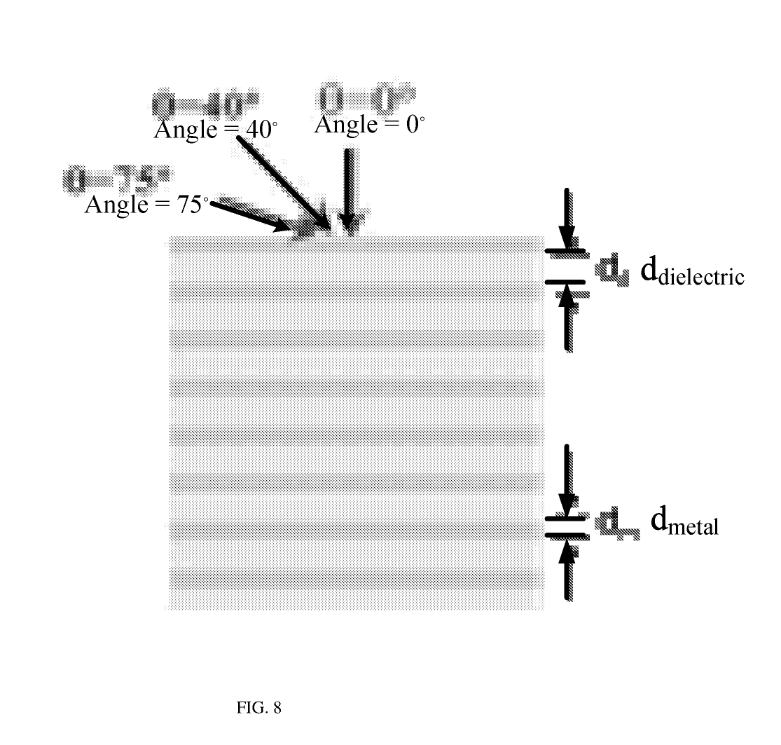

In practical systems, different materials may be used. The available materials will typically be determined by the deposition process available and the desired wavelength of operation. For operation at 1.55 micron wavelength using CMOS compatible materials with Atomic Layer Deposition, two material systems have been identified, namely, Silicon-Silver (Si—Ag) and Al₂O₃—W. Since these metamaterial structures are used as a cladding layer, a criterion for the SIS stacks to satisfy is with regard to the ability to maintain efficient bandgap characteristics over the range of incidence angles defined by the propagating, fundamental mode in a MIM waveguide. FIG. 6 illustrates selected results of a simulation of the bandgap properties of the Si—Ag material system over the range of incidence angles that may be required for certain waveguide applications. The results in this Figure indicate that the Si/Ag stack may remain operational over a wide angular range, 0 degrees to 75 degrees. FIG. 7 illustrates selected results from simulations for the two material systems under evaluation in terms of the magnitude of the reflectivity as a function of the angle of incidence. FIG. 8 illustrates the definition for angle of incidence upon the stack using plane wave excitation, where the peak reflectivity at the center wavelength of the bandgap is tracked as the angle of incidence is varied.

The results discussed above indicate that both two-material system options are capable of being synthesized into SIS stacks with reflectivities greater than 90% under normal incidence conditions of the plane wave excitation, giving the capability to manufacture the waveguides with appropriate tolerances. In simulations, the optimized design using the Si—Ag material system outperformed the other candidate material system (Al₂O₃—W) using these two figures of merit as the evaluation criteria, with multilayer metal and dielectric layer thicknesses of 10.5 nm and 8.3 nm, respectively.

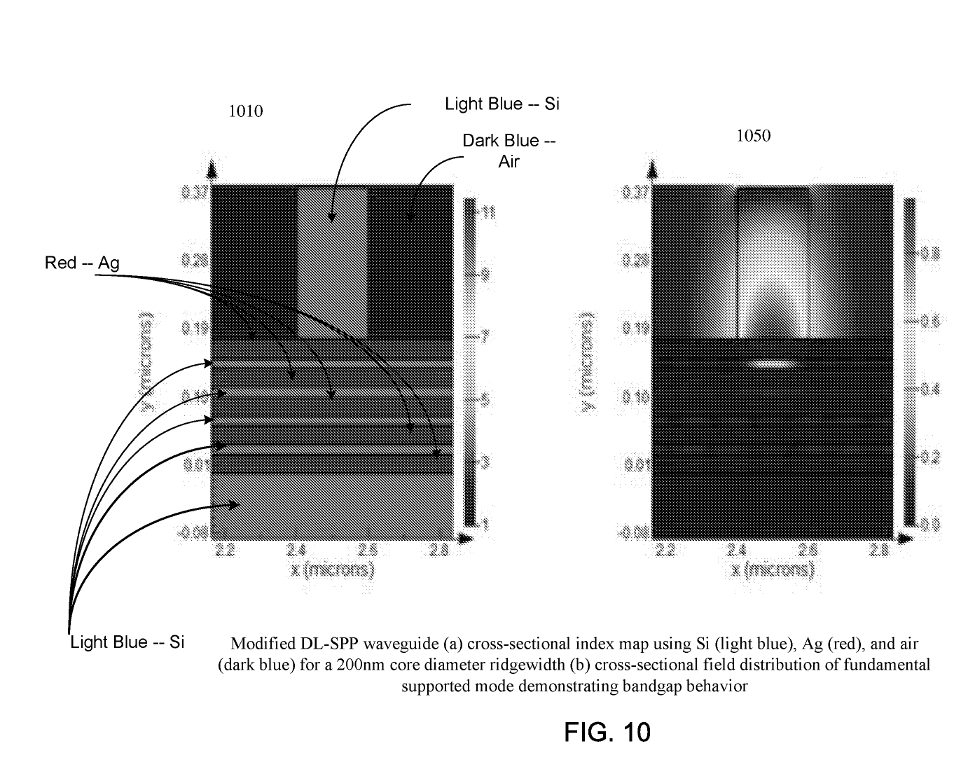

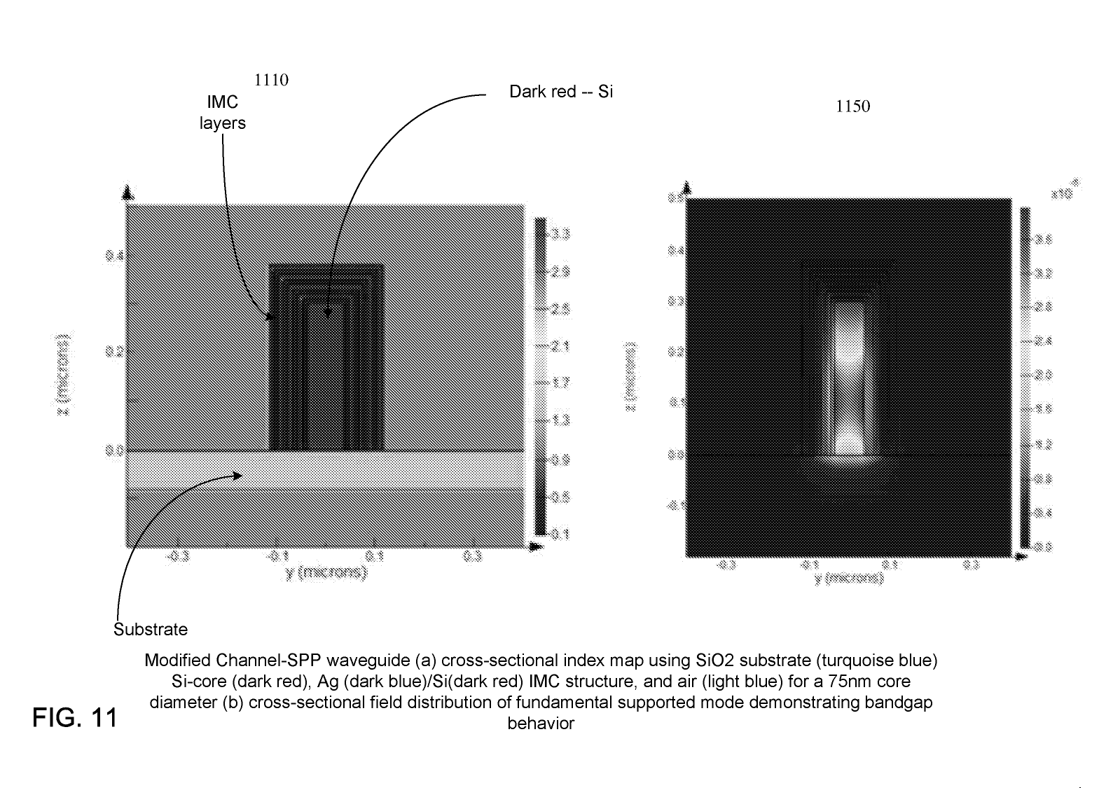

The discussion above is for planar layer structures where the confinement due to the bandgap stacks was limited to one dimension. FIG. 10 and FIG. 11 provide two examples of the SIS bandgap stacks applied to confine in two dimensions the optical filed in real waveguide structures.

The Dielectric-Loaded Surface Plasmon Polariton (“DL-SPP”) waveguide geometry used within these simulation-based evaluations is depicted in the cross-sectional index map 1010 shown on the left of FIG. 10 that follows with a Si-core width of 250 nm. The waveguide geometry has a Si-substrate (light blue), an SIS stack using Si (light blue) and Ag (dark red) layers grown on top, followed by a Si-core (light blue) surrounded by air (dark blue). A modal distribution superimposed on the waveguide cross sectional index map 1050 is shown on the right of FIG. 10.

The other waveguide architecture is a Channel Surface Plasmon Polariton (“Channel-SPP”) configuration, which provides good confinement levels and pitch for optical interconnects. Left side of FIG. 11 shows the cross sectional index map 1110 of the waveguide geometry where the 75 nm Si-core (dark red) is fabricated on top of a SiO₂ substrate and the SIS structure is deposited to surround the core uniformly (or substantially uniformly). The right side of FIG. 11 (the portion denoted with numeral 1050) shows the corresponding modal distribution of the fundamental mode superimposed on the cross sectional index map, demonstrating the ability to tailor the dimensions of the SIS structure in order to operate the waveguide cladding in a bandgap mode, thus leading to low propagation loss while maintaining a high level of field confinement. In this case, by measuring the spatial extent of the field propagating through the intermetallic matrix composite-based (IMC-based) claddings, the supportable waveguide pitch was ˜240 nm.

Non-local effects may be incorporated into the calculation of the fields and the various layer properties required to result in bandgap resonance conditions. Non-locality is a problem when one is dealing with free space accelerated electrons, and it is also a problem for measuring metallic properties at very low temperature when the low temperature causes the mean-free path to extend far beyond the “classical skin depth.” See, for example, Palik, Handbook of Optical Constants of Solids, 1985, at 278. In the case of a resonant stack, however, each metal layer, even at room temperature, is thin enough to reduce the effects of phonon scattering and the layers begin to take on properties of mesoscopic systems; in different terms, the electrons accelerated by the field start to show ballistic properties. While non-local effects are usually relatively small for very thin single layers, the ballistic effects can create large errors in the apparent loss values of the materials if not correctly incorporated into the simulation process.

The features described throughout this document may be present individually, or in any combination or permutation, except where the presence or absence of specific elements/limitations is inherently required, explicitly indicated, or otherwise made clear from context.

Although the process steps may be described serially in this document, certain steps may be performed by same and/or separate elements in conjunction or in parallel, asynchronously or synchronously, in a pipelined manner, or otherwise. There is no particular requirement that the steps be performed in the same order in which this description lists them or the Figures may show them, except where a specific order is inherently required, explicitly indicated, or is otherwise made clear from the context. Furthermore, not every illustrated step may be required in every embodiment in accordance with the concepts described in this document, while some steps that have not been specifically illustrated may be desirable or necessary in some embodiments in accordance with the concepts. It should be noted, however, that specific embodiments/variants/examples use the particular order(s) in which the steps are shown and/or described.

This document describes in detail the inventive apparatus, methods, and articles of manufacture for plasmonic SIS waveguides. This was done for illustration purposes and, therefore, the foregoing description is not necessarily intended to limit the spirit and scope of the invention(s) described. Neither the specific embodiments of the invention(s) as a whole, nor those of their features necessarily limit the general principles underlying the invention(s). The specific features described herein may be used in some embodiments, but not in others, without departure from the spirit and scope of the invention(s) as set forth herein. Various physical arrangements of components and various step sequences also fall within the intended scope of the invention(s). Many additional modifications are intended in the foregoing disclosure, and it will be appreciated by those of ordinary skill in the pertinent art that in some instances some features will be employed in the absence of a corresponding use of other features. The embodiments described above are illustrative and not necessarily limiting, although they or their selected features may be limiting for some claims. The illustrative examples therefore do not necessarily define the metes and bounds of the invention(s) and the legal protection afforded the invention(s).

What is claimed is:

1. A plasmonic waveguide comprising a first stack, a second stack, and a core dielectric layer, the core dielectric layer being sandwiched between the first stack and the second stack, wherein the first stack and the second stack operate in a bandgap condition.

2. A plasmonic waveguide as in claim 1, wherein the first stack comprises a first plurality of metal layers and a first plurality of stack dielectric layers separating the layers of the first plurality of metal layers, and the second stack comprises a second plurality of metal layers and a second plurality of stack dielectric layers separating the layers of the second plurality of metal layers.

3. A plasmonic waveguide as in claim 2, wherein thickness of each metal layer of the first and second pluralities of metal layers is equal to a first metal thickness dimension, and thickness of each stack dielectric layer of the first and second pluralities of stack dielectric layers is equal to a second dielectric thickness dimension.

4. A plasmonic waveguide as in claim 2, wherein thickness of each metal layer of the first and second pluralities of metal layers is substantially equal to a first metal thickness dimension, and thickness of each stack dielectric layer of the first and second pluralities of stack dielectric layers is substantially equal to a second dielectric thickness dimension.

5. A plasmonic waveguide as in claim 2, wherein:
the first stack comprises a first plurality of metal layers and a first plurality of stack dielectric layers separating the layers of the first plurality of metal layers, the first plurality of metal layers comprises a first adjacent metal layer that is adjacent to the core dielectric layer and two or more other metal layers of the first plurality of metal layers;
the second stack comprises a second plurality of metal layers and a second plurality of stack dielectric layers separating the layers of the second plurality of metal layers, the second plurality of metal layers comprises a second adjacent metal layer that is adjacent to the core dielectric layer and two or more other metal layers of the second plurality of metal layers;
thickness of each metal layer of the two or more other metal layers of the first plurality of metal layers and of the two or more other metal layers of the second plurality of metal layers is equal to a first metal thickness dimension; and
thickness of each metal layer of the first adjacent metal layer and the second adjacent metal layer is equal to a second metal thickness dimension that is different from the first thickness dimension.

6. A plasmonic waveguide comprising a first stack, a second stack, and a core dielectric layer, the core dielectric layer being sandwiched between the first stack and the second stack, wherein the first stack and the second stack operate in bandgap condition, and wherein the stacks are designed to enable an optical mode to propagate along the core dielectric layer with a dimension substantially smaller than the wavelength of light of the optical mode.

7. A plasmonic waveguide as in claim 6, wherein the propagation loss of the mode is reduced below propagation loss of an equivalent MIM waveguide.

8. A plasmonic waveguide as in claim 7, wherein the propagation loss of the mode is reduced by at least two orders of magnitude below the propagation loss of the equivalent MIM waveguide.

9. A plasmonic waveguide as in claim 6 wherein the propagation loss of the mode is reduced due to reduction of the level of the optical field in the metal regions of the waveguide.

10. A plasmonic waveguide comprising:
a core dielectric layer; and
means for enabling an optical mode to propagate along the core dielectric layer with a propagation loss per unit length along direction of propagation is below propagation loss per unit length of an optical mode propagating along a dielectric layer of a Metal-Insulator-Metal (MIM) optical waveguide with a dielectric layer similar to the core dielectric layer in dimensions and optical properties.

11. A metal/dielectric stack wherein the reflectivity remains at its maximum level over a wide range of angles of incidence of the optical signal.

12. A metal/dielectric stack as in claim 11, wherein the reflectivity remains above 90% over a range of angles of incidence ranging from 0 degrees to 75 degrees.

13. A metal/dielectric stack comprising means for confining and guiding an optical signal in two dimensions.

14. A metal/dielectric stack optimized for low loss plasmonic confinement and that is further optimized to account for non-local effects.

15. A plasmonic waveguide comprising a substantially cylindrical core dielectric guide and a substantially cylindrical stack surrounding the core dielectric guide, wherein the stack operates in a bandgap condition.

16. A plasmonic waveguide as in claim 15, wherein the stack comprises a plurality of substantially cylindrical metal layers and a plurality of substantially cylindrical stack dielectric layers separating the layers of the first plurality of metal layers.
